(19) United States
(12) Patent Application Publication
(10) Pub. No.: US 2008/0157977 A1
(43) Pub. Date: Jul. 3, 2008

(54) WIRELESS TAG READER/WRITER, COMMUNICATION METHOD THEREOF, AND WIRELESS TAG RELATING TO THE COMMUNICATION METHOD

(75) Inventor: Fusao Hori, Izu-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: TOSHIBA TEC KABUSHIKI KAISHA, Tokyo (JP)

(21) Appl. No.: 12/044,065

(22) Filed: Mar. 7, 2008

Related U.S. Application Data
(63) Continuation-in-part of application No. 11/773,489, filed on Jul. 5, 2007.

(30) Foreign Application Priority Data
Jul. 10, 2006 (JP) 2006-189396
Jun. 19, 2007 (JP) 2007-161338

(51) Int. Cl. G08B 13/14

(52) U.S. Cl. 340/572.7

(57) ABSTRACT

A terminal antenna which is an antenna having an end section thereof terminated is provided, and the terminal antenna is electromagnetic coupled with an antenna of a wireless tag to be communicated with. In this manner, remaining electric power and excess electric power move to the terminal antenna and converted to thermal energy at a termination. As an embodiment, for example, a communication antenna is made facing in a non-contact manner part or whole of a closed flat plane or an open flat plane formed by a wireless tag antenna and electromagnetic coupled with the wireless tag antenna, and the terminal antenna is made facing in a non-contact manner part or whole of the closed flat plane or the open flat plane formed by the wireless tag antenna to be electromagnetic coupled with the wireless tag antenna.

### CROSS-REFERENCE TO RELATED APPLICATIONS

This application is based upon and claims the benefit of priority from the prior Japanese Patent Application No. 2007-161338 filed on 19 Jun. 2007 which is based upon and claims the benefit of priority from the prior Japanese Patent Application No. 2006-189396 filed on 10 Jul. 2006, and the prior U.S. patent application Ser. No. 11/773,489 filed on 5 Jul. 2007, the entire contents of which are incorporated herein by reference.

### BACKGROUND OF THE INVENTION

1. Field of the Invention

The present invention relates to a wireless tag reader/writer that transmits and receives a signal to and from a wireless tag, a communication method of the wireless tag reader/writer, and a wireless tag using the communication method. More particularly, the present invention relates to a wireless tag reader/writer that reduces an electric wave emitted from a wireless tag at communication, a communication method of the wireless tag reader/writer, and a wireless tag relating to the communication method.

2. Description of the Related Art

Conventional communication of a wireless tag has been carried out by electromagnetic coupling an entire antenna of the wireless tag and an antenna of a wireless tag reader/writer of an inspection device. However, there has been a problem that a magnetic field is generated to emit an electric wave at communication, and when communication is carried out in a state where wireless tags exist densely, whether an electric wave received by a wireless tag reader/writer is generated by a wireless tag to be communicated with or by an adjacent wireless tag cannot be discriminated. This problem significantly occurs in case an electric wave antenna having a long communication distance is used.

For example, Jpn. Pat. Appln. Publication No. 2003-263611 (hereinafter referred to as Patent Document 1) shows a conventional technique relating to the above. Patent Document 1 describes a technique in which an antenna coil of a reader/writer and an antenna coil of a wireless tag are electromagnetic coupled, the reader/writer receives an impedance signal that changes in accordance with change of an impedance due to the electromagnetic coupling of an antenna of the wireless tag, and whether the wireless tag is in a state capable of reading and writing is determined by the impedance signal received by the reader/writer.

However, in conventional techniques such as one described in Patent Document 1, there is no consideration with respect to an electric wave emitted from a wireless tag, and reading and writing of a specific wireless tag among wireless tags in a dense state are not considered as a problem. For this reason, in the conventional techniques, there has been a problem that leakage of an electric wave in reading and writing of information of a wireless tag cannot be reduced.

In addition, in inspection of a wireless tag in a manufacturing process of wireless tags, measures have been made by providing a blocking plate around a wireless tag to be inspected. However, there has been a problem that effective blocking of leakage of an electric wave is difficult, and work efficiency is also not excellent.

### BRIEF SUMMARY OF THE INVENTION

It is an object of the present invention to provide a wireless tag reader/writer that restricts emission of an unnecessary electric wave at reading and writing of a wireless tag, a communication method of the wireless tag reader/writer, and a wireless tag relating to the communication method.

In an aspect of the present invention, the wireless tag reader/writer that transmits and receives information to and from a wireless tag includes a communication antenna which is an antenna allocated so as to be electromagnetic coupled with a wireless tag antenna which is an antenna of the wireless tag to be communicated with in a non-contact manner; a terminal antenna which is an antenna that is allocated so as to be electromagnetic coupled with the wireless tag antenna in a non-contact manner, and has an end section thereof terminated; and a reader/writer that carries out signal processing.

### BRIEF DESCRIPTION OF THE DRAWINGS

FIG. 1A is a view showing an outline of a wireless tag reader/writer according to a first embodiment of the present invention;

FIG. 1B is a view showing an example of an open flat plane 107 formed by a communication antenna 103;

FIG. 1C is a view showing an example of an open flat plane 108 formed by a terminal antenna 105;

FIG. 1D is a view showing an example of a closed flat plane 109 formed by an antenna 102 of a wireless tag to be inspected;

FIG. 2A is a view showing an example in which both the communication antenna 103 and the terminal antenna 105 are allocated above a wireless tag 101 to be communicated with;

FIG. 2B is a view showing an example in which the communication antenna 103 is allocated above the wireless tag 101, and the terminal antenna 105 is allocated below the wireless tag 101;

FIG. 2C is a view showing an example in which the communication antenna 103 is allocated below the wireless tag 101, and the terminal antenna 105 is allocated above the wireless tag 101;

FIG. 3 is a view showing the wireless tag reader/writer of the first embodiment viewed from the top;

FIG. 4A is a view showing an outline of the wireless tag reader/writer according to a second embodiment of the present invention;

FIG. 4B is a view showing an example in which a communication antenna 303 and a terminal antenna 305 are allocated above a wireless tag 301;

FIG. 5 is a view showing the wireless tag reader/writer of the second embodiment viewed from the top;

FIG. 6A is a view showing an outline of the wireless tag reader/writer according to a third embodiment of the present invention;

FIG. 6B is a view showing an example in which a communication antenna 503 and a terminal antenna 505 are allocated above a wireless tag 501;

FIG. 7 is a perspective view of the wireless tag reader/writer of the third embodiment;

FIG. 8 is a view showing an inspection method in case a wireless tag 601 to be inspected is arranged on a sheet 601a; and

FIG. 9 is a view showing an outline of a configuration of the wireless tag reader/writer of the present embodiment.

### DETAILED DESCRIPTION OF THE INVENTION

Throughout this description, the embodiments and examples shown should be considered as exemplars, rather than limitations on the apparatus and methods of the present invention.

Hereinafter, embodiments of the present invention will be described with reference to the accompanying drawings. In the present invention, a wireless tag reader/writer includes a device that reads information from a wireless tag or a device that writes information in a wireless tag, or a device that carries out both reading and writing of information. In addition, the wireless tag means a storage medium capable of wireless communication, and normally has an antenna and an IC chip. The wireless tag may further have a calculating function. The wireless tag desirably has a size to be capable of being carried around, however, may have a minute size. The wireless tag is sometimes called an RFID (Radio Frequency Identification).

### Outline of Embodiment

First, an outline of a mechanism of the wireless tag reader/writer of the present embodiment will be described. The wireless tag reader/writer of the present embodiment is provided with a terminal antenna which is an antenna having an end section thereof terminated. The terminal antenna is electromagnetic coupled with an antenna of a wireless tag to be communicated with.

By constituting in the above manner, remaining electric power and excess electric power are transferred to the terminal antenna, and are converted into thermal energy at a termination.

The embodiments for realizing the above mechanism will be sequentially described below.

Next, an outline of the present embodiment will be described. FIG. 9 is a view showing an outline of a configuration of the wireless tag reader/writer of the present embodiment.

A wireless tag 910 includes a memory 911 which is a storage device, a wireless tag control section 912 that reads and writes data from and in the memory 911, a power generating section 915 that supplies power by rectifying and stabilizing a received modulated electromagnetic wave, a modulating section 913 that modulates the data sent out from the wireless tag control section 912 and sends out the data to a wireless tag antenna 916, and a demodulating section 914 that demodulates the received modulated electromagnetic wave and sends out the electromagnetic wave to the wireless tag control section 912.

A wireless tag reader/writer 920 of the present embodiment includes a communication antenna 921a which is an antenna for transmitting and receiving a signal to and from a wireless tag by an electromagnetic wave, a terminal antenna 921b having an end section thereof terminated, and a reader/writer 920a that carries out signal-processing.

The reader/writer 920a includes a reader/writer control section 926 that controls hardware which communicates with and is connected to the wireless tag 910, a modulating section 922 that modulates data sent out from the reader/writer control section 926, a transmission amplifier 923 that amplifies a modulated signal and sends out the signal to the communication antenna 921a, a receiving amplifier 924 that amplifies a received modulated electromagnetic wave, a demodulating section 925 that demodulates the received modulated signal, and an interface 930 that is connected to, for example, a host device such as a personal computer, to exchange data. In addition, the reader/writer control section 926 includes a CPU 927, and a ROM 928 and a RAM 929 that store data.

The communication antenna 921a and the terminal antenna 921b may be contained in one enclosure together with the wireless tag reader/writer 920 in an integrated manner to constitute a stationary or a hand-held wireless tag reader/writer. Alternatively, the communication antenna 921a and the terminal antenna 921b may be contained in an enclosure separate from the wireless tag reader/writer 920.

Next, an outline of the wireless tag reader/writer of the present embodiment will be described. The wireless tag reader/writer of the present embodiment includes a communication antenna which is an antenna allocated so as to be electromagnetic coupled with a wireless tag antenna which is an antenna of a wireless tag to be communicated with in a non-contact manner, a terminal antenna that is an antenna which is allocated so as to be electromagnetic coupled with the wireless tag antenna in a non-contact manner, and has an end section thereof terminated, and a reader/writer that carries out signal processing.

In addition, the wireless tag communication method of the present embodiment includes: electromagnetic coupling the communication antenna which is an antenna that transmits and receives an electromagnetic wave of the wireless tag reader/writer that communicates with the wireless tag with the wireless tag antenna which is an antenna of the wireless tag to be communicated with; electromagnetic coupling the terminal antenna which is an antenna having an end section thereof terminated with the wireless tag antenna; and the wireless tag reader/writer transmitting and receiving information to and from the wireless tag.

Further, the wireless tag of an embodiment of the present invention is the wireless tag that carries out communication with the wireless tag reader/writer, including: the communication antenna which is an antenna that faces in a non-contact manner at least part of a closed flat plane or an open flat plane formed by the wireless tag antenna which is an antenna of the wireless tag to be communicated with so as to be electromagnetic coupled with the wireless tag antenna; the terminal antenna which is an antenna that faces in a non-contact manner at least part of the closed flat plane or open flat plane formed by the wireless tag antenna, is allocated so as to be electromagnetic coupled with the wireless tag antenna, and has an end section thereof terminated; and the reader/writer that carries out signal processing, wherein the wireless tag antenna moves remaining electric power and excess electric power in the wireless tag to the terminal antenna.

### First Embodiment

Hereinafter, as a first embodiment, description will be made with respect to an example in which the wireless tag reader/writer includes the terminal antenna as a member separate from the communication antenna, and the terminal antenna is electromagnetic coupled with an antenna of the wireless tag to transfer remaining electric power and excess electric power to the terminal antenna and convert the electric power to thermal energy.

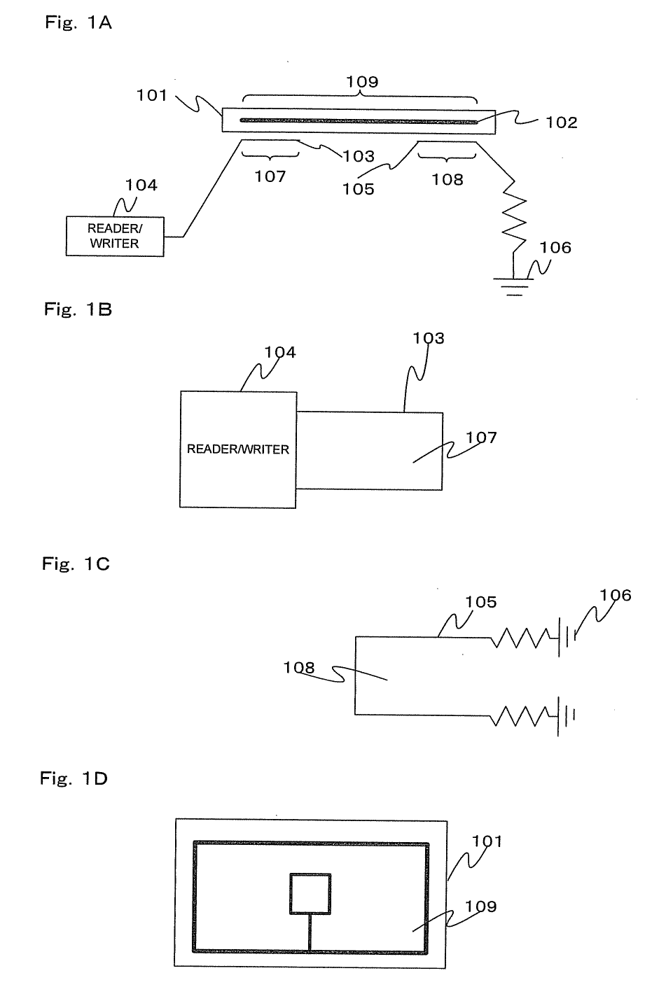

FIG. 1A is a view showing an outline of the wireless tag reader/writer according to the first embodiment of the present invention. In FIG. 1A shows a state of when the wireless tag reader/writer of the embodiment is viewed from the side.

As shown in FIG. 1A, the wireless tag reader/writer of the present embodiment includes a communication antenna 103 that faces in a non-contact manner to part or whole of a closed flat plane or open flat plane 109 formed by a wireless tag antenna 102 which is an antenna of a wireless tag 101 to be communicated with, and is allocated so as to be electromagnetic coupled with the wireless tag antenna 102; a terminal antenna 105 that faces in a non-contact manner to part or whole of the closed flat plane or open flat plane 109 formed by the wireless tag antenna 102, is allocated so as to be electromagnetic coupled with the wireless tag antenna 102, and has an end section 106 terminated; and a reader/writer 104 that carries out signal processing.

The communication antenna 103 may form a closed flat plane or an open flat plane. In addition, the terminal antenna 105 may form a closed flat plane or an open flat plane.

FIG. 1B shows an example of an open flat plane 107 formed by the communication antenna 103. As shown in FIG. 1B, the open flat plane formed by the communication antenna 103 indicates a range in which the communication antenna 103 can communicate in a flat plane to which an open figure formed by the communication antenna 103 belongs. The term “open flat plane” is used as having the above-described meaning.

The communication antenna 103 may form a closed figure.

FIG. 1C shows an example of an open flat plane 108 formed by the terminal antenna 105. The terminal antenna 105 may form a closed figure.

In addition, FIG. 1D shows an example of the closed flat plane 109 formed by the antenna 102 of the wireless tag to be inspected. As shown in FIG. 1D, the closed flat plane of the antenna 102 of the wireless tag to be inspected indicates a range in which the antenna 102 of the wireless tag to be inspected can communicate in a flat plane to which a closed figure formed by the antenna 102 of the wireless tag to be inspected belongs. The term “closed flat plane” is used as having the above-described meaning.

The antenna 102 of the wireless tag to be inspected may form an open flat plane.

In addition, the flat plane formed by the communication antenna means the closed flat plane or the open flat plane formed by the communication antenna. The flat plane formed by the terminal antenna means the closed flat plane or the open flat plane formed by the terminal antenna.

Next, an allocation example of the wireless tag reader/writer of the present embodiment will be described. In FIG. 1A, the communication antenna 103 and the terminal antenna 105 are both allocated below the wireless tag 101 to be communicated. Further, the following allocations are also possible.

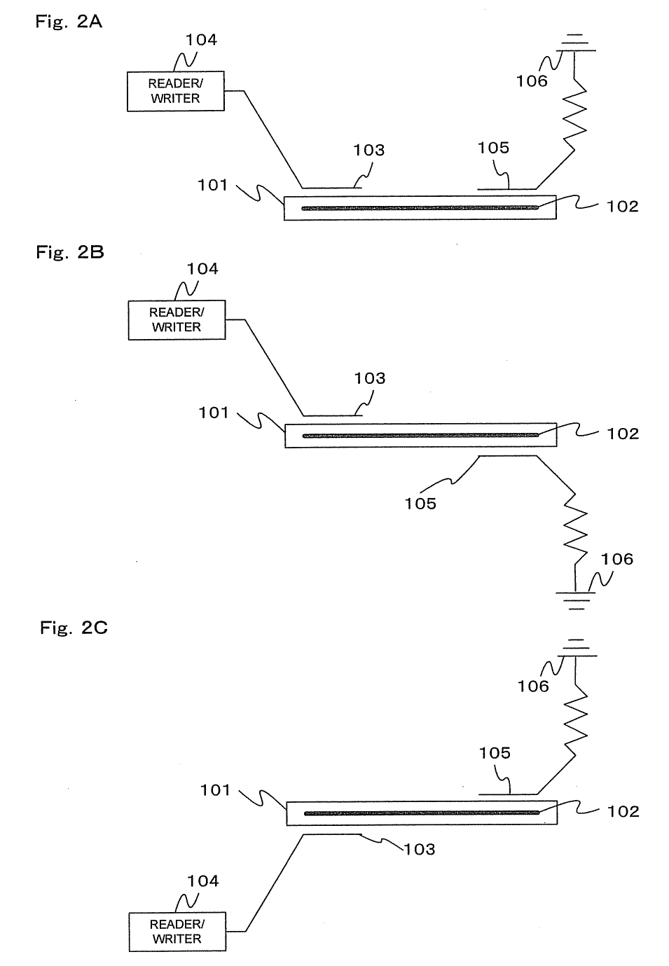

FIG. 2A shows an example in which the communication antenna 103 and the terminal antenna 105 are both allocated above the wireless tag 101 to be communicated. FIG. 2B shows an example in which the communication antenna 103 is allocated above the wireless tag 101, and the terminal antenna 105 is allocated below the wireless tag 101. FIG. 2C shows an example in which the communication antenna 103 is allocated below the wireless tag 101 and the terminal antenna 105 is allocated above the wireless tag 101.

Here, description will be made with respect to a mechanism for the wireless tag reader/writer of the first embodiment to restrict emission of an unnecessary electric wave. A wireless tag inspection method of the first embodiment allocates part of the closed flat plane or the open flat plane formed by the communication antenna 103 connected to the reader/writer 104 in a manner facing part of the closed flat plane or the open flat plane formed by the antenna 102 of the wireless tag to be inspected in a non-contact manner. Along therewith, the communication antenna is electromagnetic coupled with an antenna of the wireless tag. Further, the wireless inspection method allocates part of the closed flat plane or the open flat plane formed by the terminal antenna having an end part thereof terminated in a manner facing part or whole of a remaining section of the closed flat plane or the open flat plane formed by the antenna of the wireless tag to be inspected in a non-contact manner. Along therewith, the terminal antenna is electromagnetic coupled with the antenna of the wireless tag. Then, the wireless tag reader/writer reads information from or writes information in the wireless tag to be communicated.

When an electric current flows from the reader/writer 104 to the communication antenna, electromagnetic coupling is generated with the wireless tag antenna 102 of the wireless tag 101, and electric power is transferred to the wireless tag antenna 102, and an IC chip of the wireless tag starts operating. A signal from the IC chip is transferred to the wireless tag antenna 102, transferred to the communication antenna 103 which is electromagnetic coupled, and transferred to the reader/writer 104.

Almost 50% of the electric power applied to the communication tag antenna becomes energy for operating the wireless tag, and a remaining portion of the applied electric power moves to the terminal antenna 105 by electromagnetic coupling, and is converted to heat at the end section 106. Even in case the remaining electric power and excess electric power are applied to the communication tag antenna, such electric powers become heat at the end section 106 through the terminal antenna 105.

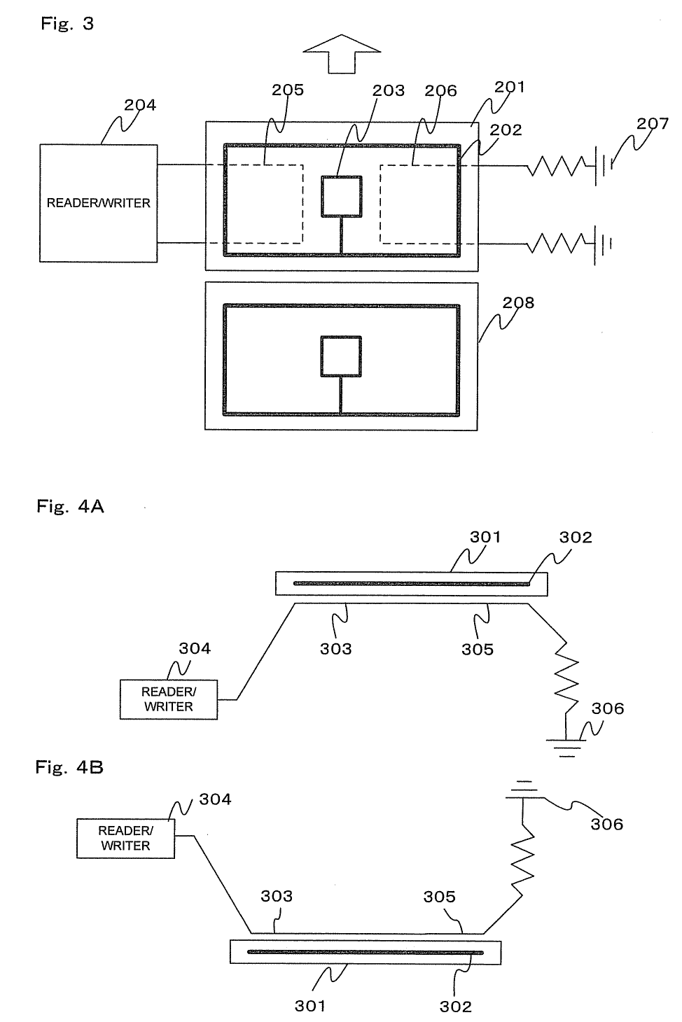

FIG. 3 is a view showing the wireless tag reader/writer according to the first embodiment of the present invention viewed from the top. FIG. 3 particularly shows an inspection process in a manufacturing process of the wireless tag. Wireless tags 201 and 208 are located close to each other and move in an arrow direction in the inspection process. A numerical number 202 indicates an antenna that moves around an IC chip 203 of the wireless tag 201. Although the antenna is illustrated as a folded dipole antenna in FIG. 3, an advantageous effect of the present invention can be obtained with the antenna of any kind. Numerical number 205 indicates a communication antenna which is connected to the reader/writer 204. Numerical number 206 indicates a terminal antenna which has a termination 207 at an end section thereof.

Here, electric power applied to the communication antenna 205 by the reader/writer 204 moves to the antenna 202 of the wireless tag being electromagnetic coupled and operates the wireless tag. Remaining electric power in the wireless tag and excess electric power applied to the wireless tag move to the terminal antenna 206 being electromagnetic coupled, and are converted to heat at the termination 207.

According to the wireless tag reader/writer and the wireless tag communication method of the present embodiment configured in the above manner, emission of an electric wave to space is restricted and the reader/writer can receive only a signal from the wireless tag 201 currently being inspected.

### Second Embodiment

Hereinafter, as the second embodiment, description will be made with respect to an example in which the wireless tag reader/writer includes the terminal antenna as a member integrated by being electrically connected with the communication antenna, and the terminal antenna is electromagnetic coupled with the antenna of the wireless tag to move remaining electric power and excess electric power to the terminal antenna and to convert the electric powers to thermal energy.

FIG. 4A is a view showing an outline of the wireless tag reader/writer according to the second embodiment of the present invention. FIG. 4A shows a state of the wireless tag reader/writer of the present invention viewed from the side.

In the present embodiment, a communication antenna 303 and a terminal antenna 305 are electrically connected with each other, and other configurations and a mechanism thereof are similar to those in the first embodiment. Numerical number 301 indicates a wireless tag and includes an antenna 302. A reader/writer 304 is connected to the communication antenna 303. The terminal antenna 305 has a termination 306 at an end section thereof. Although the communication antenna 303 and the terminal antenna 305 are allocated below the wireless tag 301 in FIG. 4A, the antenna 303 and the antenna 305 may be allocated above the wireless tag as shown in FIG. 4B.

FIG. 5 is a view of the wireless tag reader/writer according to the second embodiment of the present invention viewed from the top, and shows the inspection process in the manufacturing process of the wireless tag, for example. A wireless tag 401 has a wireless tag antenna 402 and an IC chip 403. The communication antenna 405 is allocated around the IC chip 403 in a manner not contacting the wireless tag, and connected to a reader/writer 404. A terminal antenna 406 is electrically connected to the communication antenna 405, allocated in a manner laminating on part of the wireless tag and not contacting the wireless tag 401, and has a termination 407 terminated at an end section thereof.

According to the wireless tag reader/writer and the wireless tag communication method of the present embodiment configured as described above, emission of an electric wave to space is restricted. In the inspection process, although a wireless tag 408 is located close to the wireless 401 under inspection and conveyed in an arrow direction, the reader/writer can receive only a signal from the wireless tag 401 currently being inspected.

### Third Embodiment

Hereinafter, as the third embodiment, description will be made with respect to an example in which the wireless tag reader/writer includes the terminal antenna as a member separate from the communication antenna, the terminal antenna is allocated in a manner facing the communication antenna to make up two layers, and further the communication antenna and the terminal antenna are electromagnetic coupled with the antenna of the wireless tag to move remaining electric power and excess electric power to the terminal antenna and convert the electric powers to thermal energy.

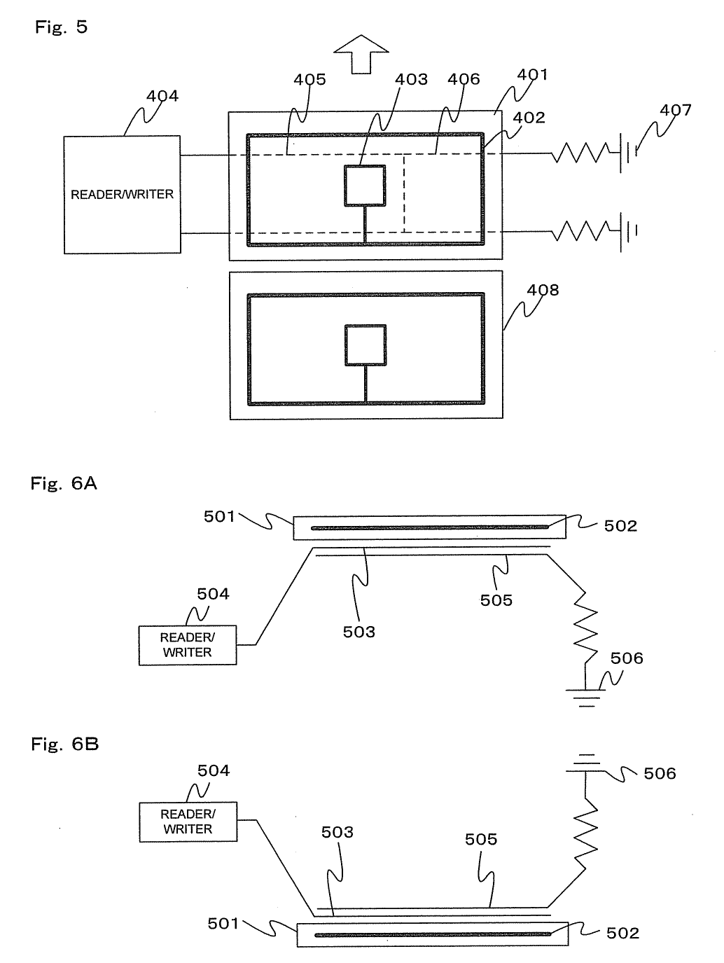

FIG. 6A is a view showing an outline of the wireless tag reader/writer according to the third embodiment of the present invention. FIG. 6A shows a state of the wireless tag reader/writer of the embodiment viewed from the side.

In the wireless tag reader/writer of the third embodiment, the closed flat plane or the open flat plane formed by a communication antenna 503 and the closed flat plane or the open flat plane formed by a terminal antenna 505 are allocated in a manner facing each other in a non-contact manner to make up two layers.

Although the communication antenna 503 and the terminal antenna 505 are allocated below a wireless tag 501, the antenna 503 and the antenna 505 may be allocated above the wireless tag as shown in FIG. 6B.

Part or whole of the closed flat plane or the open flat plane formed by the communication antenna 503 connected to a reader/writer 504 is allocated in a manner facing part or whole of the closed flat plane or the open flat plane formed by an antenna 502 of the wireless tag 501 to be inspected in a non-contact manner, and the communication antenna 503 is electromagnetic coupled with the antenna 502 of the wireless tag.

Part of the closed flat plane or the open flat plane formed by the terminal antenna 505 having an end section thereof terminated is allocated in a manner facing part or whole of the closed flat plane or the open flat plane formed by the antenna 502 of the wireless tag in a non-contact manner, and the terminal antenna 505 is electromagnetic coupled with the antenna of the wireless tag. Other configurations and a mechanism are similar to those of the first embodiment.

The wireless tag 501 has the antenna 502. The communication antenna 503 is connected to the reader/writer 504. The terminal antenna 505 has the termination 506 at the end section thereof. Although the communication antenna 503 and the terminal antenna 505 are both positioned below the wireless tag 501 in FIG. 5, any one or both of the antennas may be positioned above the wireless tag.

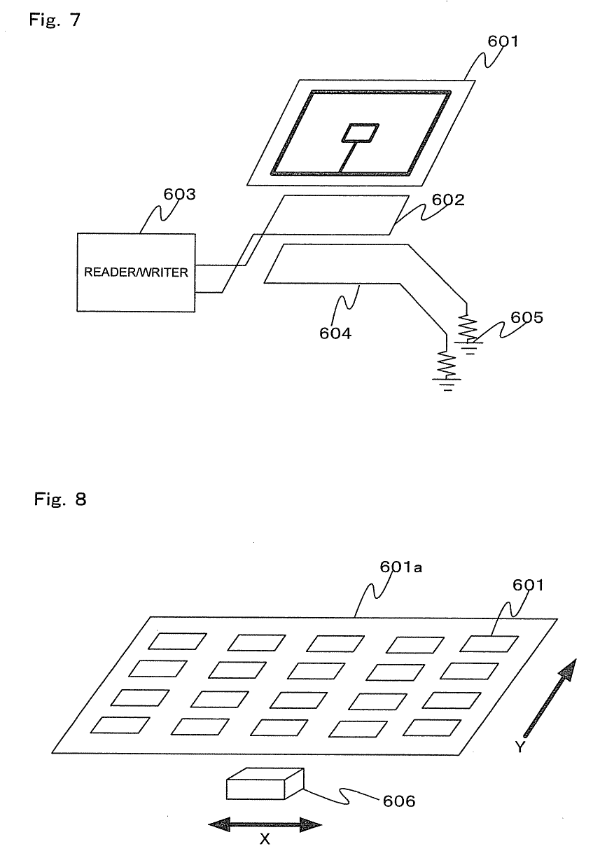

FIG. 7 is a perspective view of the wireless tag reader/writer according to the third embodiment of the present invention. Although a wireless tag 601, a communication antenna 602, and a terminal antenna 604 are drawn with large space between each other in FIG. 7 for easier understanding, such space is desirably smaller. The communication antenna 602 is connected to a reader/writer 603, and the terminal antenna 604 has a termination 605 at the end section thereof.

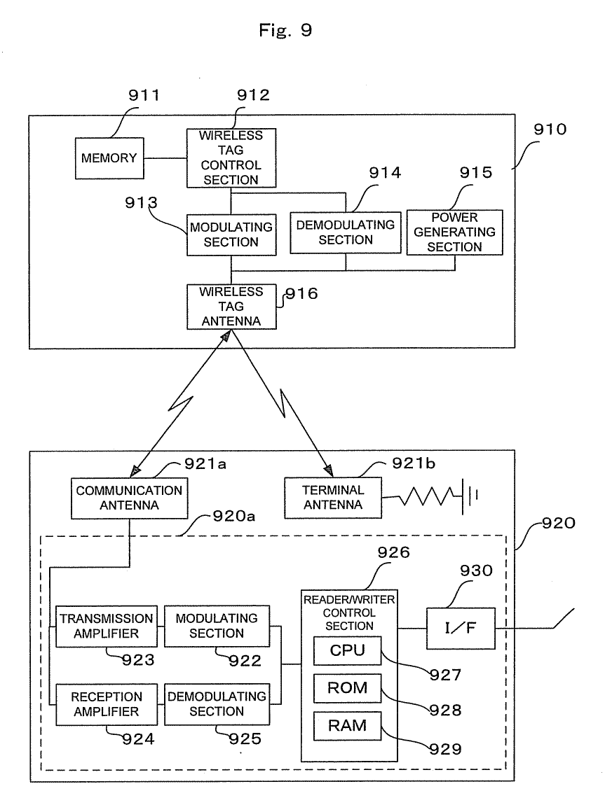

FIG. 8 is a view showing an inspection method of when the wireless tags 601 to be inspected is arranged on a sheet 601a. A wireless tag reader/writer 606 inspects the wireless tags 601 by moving in a direction of an arrow X and communicating with the wireless tags 601 sequentially. After the wireless tag reader/writer 606 inspects one row in a horizontal direction, the sheet 601a moves in a direction of an arrow Y, and the wireless tag reader/writer 606 inspects a next row. By moving the wireless tag reader/writer 606 in the above manner, the wireless tags can be inspected more efficiently.

### Advantageous Effect of Present Embodiment

In the present embodiment, the closed flat plane or the open flat plane formed by the communication antenna 602 and the closed flat plane or the open flat plane formed by the terminal antenna 604 are allocated in a manner facing each other on a non-contact basis to make up two layers, and each of such antennas is electromagnetic coupled with the antenna of the wireless tag to be communicated with. Therefore, almost all of electric waves emitted to space are converted into heat by the termination 605 of the terminal antenna.

According to the wireless tag inspection method of the present embodiment configured in the above manner, most of emission of electric waves to space is restricted, and the reader/writer can receive only a signal from the wireless tag 601 currently being inspected.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alteration should therefore be seen as within the scope of the present invention.

What is claimed is:

1. A wireless tag reader/writer that transmits and receives information to and from a wireless tag, comprising:
a communication antenna which is an antenna allocated so as to be electromagnetic coupled with a wireless tag antenna which is an antenna of the wireless tag to be communicated with in a non-contact manner;
a terminal antenna which is an antenna that is allocated so as to be electromagnetic coupled with the wireless tag antenna in a non-contact manner, and has an end section thereof terminated; and
a reader/writer that carries out signal processing.

2. A wireless tag reader/writer that transmits and receives information to and from a wireless tag, comprising:
a communication antenna which is an antenna that faces in a non-contact manner at least part of a flat plane formed by a wireless tag antenna which is an antenna of the wireless tag to be communicated with;
a terminal antenna which is an antenna that faces in a non-contact manner at least part of the flat plane formed by the wireless tag antenna, is allocated so as to be electromagnetic coupled with the wireless tag antenna, and has an end section thereof terminated; and
a reader/writer that carries out signal processing.

3. The wireless tag reader/writer according to claim 2, wherein
a flat plane formed by the communication antenna is a closed flat plane.

4. The wireless tag reader/writer according to claim 2, wherein
a flat plane formed by the communication antenna is an open flat plane.

5. The wireless tag reader/writer according to claim 2, wherein
a flat plane formed by the terminal antenna is a closed flat plane.

6. The wireless tag reader/writer according to claim 2, wherein
a flat plane formed by the terminal antenna is an open flat plane.

7. The wireless tag reader/writer according to claim 1 or 2, wherein
at least one of the communication antenna and the terminal antenna is allocated above the closed flat plane formed by the wireless tag antenna.

8. The wireless tag reader/writer according to claim 1 or 2, wherein
at least one of the communication antenna and the terminal antenna is allocated above the open flat plane formed by the wireless tag antenna.

9. The wireless tag reader/writer according to claim 1 or 2, wherein
at least one of the communication antenna and the terminal antenna is allocated below the closed flat plane formed by the wireless tag antenna.

10. The wireless tag reader/writer according to claim 1 or 2, wherein
at least one of the communication antenna and the terminal antenna is allocated below the open flat plane formed by the wireless tag antenna.

11. A wireless tag communication method, comprising:
electromagnetic coupling a communication antenna which is an antenna that transmits and receives an electromagnetic wave of a wireless tag reader/writer that communicates with a wireless tag with a wireless tag antenna which is an antenna of the wireless tag to be communicated with;
electromagnetic coupling a terminal antenna which is an antenna having an end section thereof terminated with the wireless tag antenna; and
the wireless tag reader/writer transmits and receives information to and from the wireless tag.

12. The wireless tag communication method according to claim 11, wherein
the communication antenna is made facing in a non-contact manner at least part of a flat plane formed by the wireless tag antenna to be electromagnetic coupled with the wireless tag antenna; and
the terminal antenna is made facing in a non-contact manner at least part of the flat plane formed by the wireless tag antenna to be electromagnetic coupled with the wireless tag antenna.

13. The wireless tag communication method according to claim 12, wherein
a flat plane formed by the communication antenna is a closed flat plane.

14. The wireless tag communication method according to claim 12, wherein
a flat plane formed by the communication antenna is an open flat plane.

15. The wireless tag communication method according to claim 12, wherein
a flat plane formed by the terminal antenna is a closed flat plane.

16. The wireless tag communication method according to claim 12, wherein
a flat plane formed by the terminal antenna is an open flat plane.

17. The wireless tag communication method according to claim 11 or 12, wherein
at least one of the communication antenna and the terminal antenna is allocated above the closed flat plane formed by the wireless tag antenna.

18. The wireless tag communication method according to claim 11 or 12, wherein
at least one of the communication antenna and the terminal antenna is allocated above the open flat plane formed by the wireless tag antenna.

19. The wireless tag communication method according to claim 11 or 12, wherein
at least one of the communication antenna and the terminal antenna is allocated below the closed flat plane formed by the wireless tag antenna.

20. The wireless tag communication method according to claim 11 or 12, wherein
at least one of the communication antenna and the terminal antenna is allocated below the open flat plane formed by the wireless tag antenna.

21. The wireless tag communication method according to claim 11 or 12, wherein
the communication antenna is made facing in a non-contact manner at least part of a flat plane formed by the wireless tag antenna to be electromagnetic coupled with the wireless tag antenna, and
the terminal antenna is made facing in a non-contact manner at least part of the flat plane formed by the wireless tag antenna to make up two layers to be electromagnetic coupled with the wireless tag antenna.

22. A wireless tag that carries out communication with a wireless tag reader/writer comprising:
a communication antenna which is an antenna that faces in a non-contact manner at least part of a flat plane formed by a wireless tag antenna which is an antenna of the wireless tag to be communicated with so as to be electromagnetic coupled with the wireless tag antenna;
a terminal antenna which is an antenna that faces in a non-contact manner at least part of the flat plane formed by the wireless tag antenna, is allocated so as to be electromagnetic coupled with the wireless tag antenna, and has an end section thereof terminated; and
a reader/writer that carries out signal processing, wherein
the wireless tag antenna moves remaining electric power and excess electric power in the wireless tag to the terminal antenna.
